(19) United States
(12) Patent Application Publication
(10) Pub. No.: US 2012/0097724 A1
(43) Pub. Date: Apr. 26, 2012

(54) Drink Holder Adapter for Large Keg Style Beverage Containers

(76) Inventors: Richard Standfest, Montgomery, TX (US); Cindy Standfest, Montgomery, TX (US)

(21) Appl. No.: 13/222,168

(22) Filed: Aug. 31, 2011

Related U.S. Application Data
(60) Provisional application No. 61/406,625, filed on Oct. 26, 2010.

(51) Int. Cl. B60R 11/00

(52) U.S. Cl. 224/545

(57) ABSTRACT

A keg-style beverage container securing device for mounting to a standard vehicle cup holder. The device is equipped with a securing member for insertion into a standard vehicle cup holder cavity, used to support a circular tray bounded by an upstanding lip. The tray is equipped with a non-slip surface to assist in securing the keg-style beverage container. Further, the upstanding lip has a gap to allow proper alignment of the handle of the beverage container, preventing rotation and providing adequate fitment thereof.

### CROSS REFERENCE TO RELATED APPLICATION

This application claims the benefit of U.S. Provisional Application No. 61/406,625 filed on Oct. 26, 2010, entitled “Drink Holder Adapter for Large Keg.”

### BACKGROUND OF THE INVENTION

1. Field of the Invention

The present invention relates to an adapter for drinker holders in vehicles to allow use with larger beverage containers and keg style beverage holders.

Many consumers carry beverages with them while traveling in vehicles. Vehicles often provide designated places for holding drinks while the vehicle is in motion. However, traditional drink holders typically do not accommodate the large beverage containers currently offered by fast food and convenient stores. One such item has been the advent of the over-sized, keg-style drink container, which is typically 32 liquid ounces in size or greater. Unfortunately, the cup dimensions for these larger drinks exceed the dimensions of standard drink receptacles provided in motor vehicles. These standard receptacles are generally sized to receive an aluminum can or small sized soft drink. Consequently, persons desiring to purchase a keg-style beverage for consumption in the vehicle must carry the drink in their lap, place the beverage on the vehicle floor or limit the container to the standard dimensions.

Furthermore, the adaption of large cups to have a smaller base suitable to fit in the standard receptacle is simply not feasible. Specifically, such a configuration results in a considerably top-heavy container when filled with liquid. Within a moving vehicle, sudden changes in lateral momentum can easily dislodge or tip over such top-heavy cups, resulting in major spills and the potential for distraction of the motorist while driving. These situations are problematic, as motor vehicle accidents may be caused by such distracting events where proper securement of large beverage containers is not provided.

These issues create a need for proper automobile securement of a beverage, particularly for those consumers who require large quantities of fluids throughout the day, and thus must carry large containers. Without specially sized drink holders, these individuals may be required to keep their drinks in their laps or on their seats, which can result in messy spills and distractions for the motorist. The present invention addresses the need to have a cup holder device capable of securing keg-style drink containers to a standard cup holder cavity.

### DESCRIPTION OF THE PRIOR ART

Several patents have been issued addressing the securing of larger drink containers while driving. However, these prior art devices do not address the issue of securing keg-style drink containers and adapters to fit standard cup holders; rather they focus on larger or smaller generic cups.

Several prior art patents describe inventions to assist in stably placing varying sizes of drink containers into a standard cup holder. Dahlquist, II, U.S. Pat. No. 4,854,468 is directed to a device for stabilizing and supporting a large cup whose base diameter exceeds the smaller diameter of a support receptacle such as is typically provided in a moving vehicle. The device includes a tubular support base having a diameter slightly smaller than the diameter of a standard can or cup receptacle and having an axial length of at least approximately half an inch. A support plate is coupled at one side to a top rim of the tubular support base, the remaining side of the support plate being attached to a base rim of a truncated support cone having a diameter greater in size than the tubular diameter and being adapted in configuration for receiving the container or cup therein.

Similarly, Chandler U.S. Pat. No. 5,088,673 is directed to an adapter for holding an enlarged drinking glass, mug or the like having a socket that is of a larger interval diameter, with a lower pedestal of a smaller outer diameter adapted to fit the console socket of a moving vehicle. Additionally, Dane U.S. Pat. No. 5,135,195 is directed to a beverage receptacle holder comprises a substantially circular first portion and a substantially circular second portion. The first portion is of a first diameter while the second portion is of a second diameter that is larger than the first diameter. This enables a typical beverage receptacle holder to hold cups, glasses, cans, mugs and other beverage receptacles of various sizes.

Finally, Evans U.S. Pat. No. 5,330,145 is directed to an adapter for enabling a traditional cup holder to support a relatively large drinking vessel including a base having an upwardly open socket large enough to receive the vessel and a downwardly projecting locking element that is small enough to fit into the traditional cup holder. The locking element rotates on the base about an eccentric axis so that when it is turned it will drive the base into a nearby upright surface and thereby hold the base firmly within the traditional cup holder.

The Dhalquist, Chandler, Dane and Evans inventions each address the issue of securely positioning a larger drink within a standard vehicle cup holder. However, they do not address the issue of keg-style beverage holders, as provided by the present invention.

Other patents describe devices to enable smaller drinks to fit securely into larger vehicle cup holders. Mitchell U.S. Pat. No. 5,174,534 is directed to an adapter is provided for adapting a container holder to support a container, such as beverage container in a substantially upright position. The adapter includes a first adapter member insertable into a receptacle in the container holder and a second adapter member adapted for mating engagement with both the first adapter member and the container to support the container in a substantially upright position. Similarly, Smith U.S. Pat. No. 5,285,953 is directed to a cup holder includes a movable adapter ring for use in selectively reducing the inner diameter of the larger upper socket that is the primary cup support.

The Mitchell and Smith patents address the issue of securely fastening a smaller size beverage within a large vehicle cup holder, as such they do not address the issue of the present invention. Namely, the issue of placing a large sized drink in small standard cup holder.

The prior art patents describe alternative structures and methods for securing large or small beverages to a standard vehicle cup holder. They fail to address the need for securement of keg-style beverage containers with a vehicle. Consequently, it is clear that the present invention substantially diverges in structural elements from the prior art, and there is a need in the art for an improvement to the existing beverage securing structures within a motor vehicle. In this regard the instant invention substantially fulfills these needs.

### SUMMARY OF THE INVENTION

In view of the foregoing disadvantages inherent in the known types of cup holder adapters now present in the prior art, the present invention provides a new cup holder adapter device wherein the same can be utilized for providing convenience for the user when required to place an overly large beverage container into a vehicle cup holder, including those containers exhibiting a protruding handle.

The present invention provides a convenient and effective device for transporting large beverage containers within conventional vehicle drink holders. The device features a round, recessed base portion sized to accommodate large, keg-style beverage containers. Further, the device may include non-slip materials on the base for preventing container sliding, along with a notch along upstanding sidewalls to accommodate handles on containers. The device has an extension member to allow the device to fit snugly into an average vehicle drink holder. Practitioners desirous of large quantities of a beverage may make use of the present invention to provide secure fitment and stable placement of such beverages in a motor vehicle, rather than holding the beverage precariously between their legs or elsewhere in the vehicle.

It is therefore an object of the present invention to provide a cup holder adapter device to allow securing of large, keg-style beverage containers in standard vehicle cup holders. It is a further object of the present invention to be easily insertable and removeable from a standard vehicle cup holder.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself, and manner in which it may be made and used, may be better understood by referring to the following description taken in connection with the accompanying drawings.

FIG. 1 is an exploded perspective view of a keg-style cup placed into the present invention, in turn placed into a standard vehicle cup holder.

FIG. 2 is a perspective view of the present invention in use, secured in a standard vehicle cup holder.

### DETAILED DESCRIPTION OF THE INVENTION

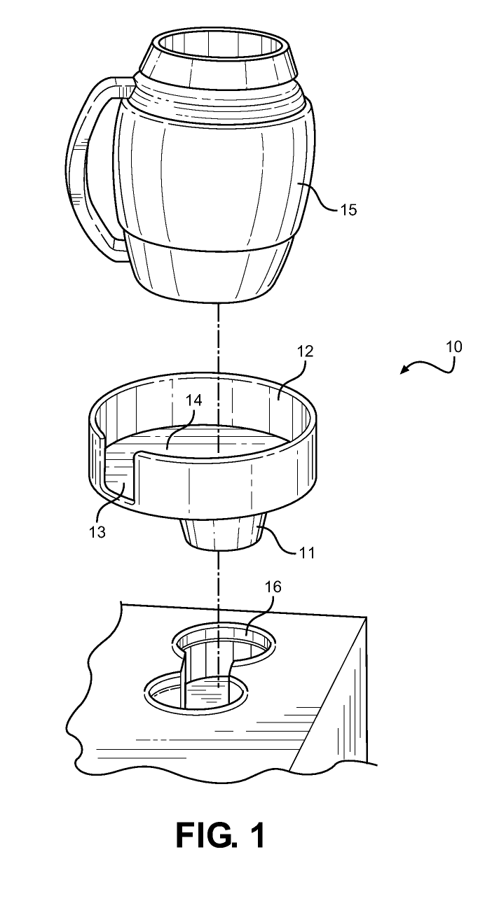

Referring now to FIG. 1, there is shown a perspective view of a keg-style cup 15 placed into the present invention 10, in turn placed into a standard vehicle cup holder 16. The device 10 has a large base tray 14, sufficient for holding a keg-style or oversized beverage container 15. The tray 14 may be coated with a textured or high friction material to prevent slippage of the container 15. Further, the tray 14 is bounded by an upstanding securing lip 12 to secure the keg-style beverage container 15 and further prevent lateral movement, including a handle opening 13 to accommodate the beverage container handle. Further, fixed to the bottom surface of the tray 14 is a protruding securing member 11, designed to be inserted into the standard vehicle cup holder 16 cavity.

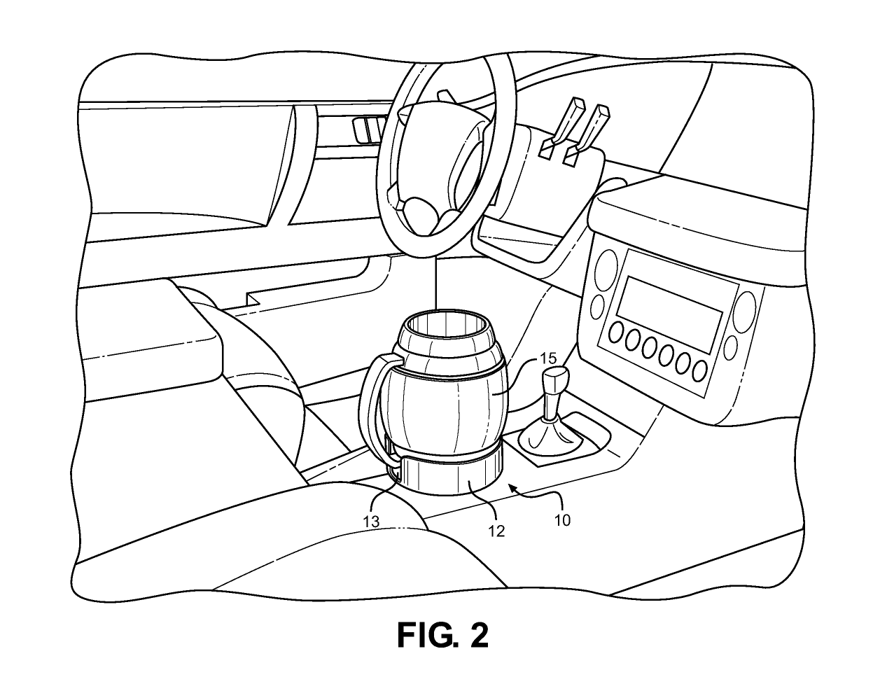

Referring now to FIG. 2, there is shown a perspective view of the present invention 10 in use, secured in a standard vehicle cup holder. A keg-style beverage container 15 is secured upon the tray 14, bounded by the securing lip 12. Further, the handle of the beverage container 15, is properly placed within the handle opening 13, properly orienting the beverage container 15 for easy access by the driver or passenger.

In use, the present invention is a device 10 that allows consumers to transport large keg-style or oversized beverage containers in standard vehicle cup holders 16. The invention may comprise a circular, flat tray 14 bounded by an exterior securing lip 12, into which a large beverage container 15 may be placed. On one side of the device may be a handle opening 13, designed to accommodate the handle on a beverage container 15. On the surface of the tray, 14 there may be non-slip material for securely holding a container in place.

The underside of the tray 14 is secured into a standard cup holder 16 using a securing member 11, which may fit snugly into a traditional cup holder. The securing member 11 can be placed centrally below the tray, or conversely in an off-center location, allowing the device to rest flat on the center console of a vehicle for added stability. The device 10 may be made of plastic or other suitable material, and may be offered in a variety of colors to suit user preferences.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A device for stabilizing and supporting a beverage container comprising:
a tray bounded by an upstanding securing lip;
said securing lip extending substantially around said tray circumference and providing an open section for engagement of a beverage container handle;
a support member adapted to engage a vehicle cup holder cavity protruding from said tray lower surface.

2) The device in claim 1, further comprising a non-slip surface applied to the tray to assist in securing the keg-style beverage container.

3) The device in claim 1, wherein said support member protrudes from a center location from said tray lower surface.

4) The device in claim 1, wherein said support member protrudes from an off-center location from said tray lower surface.
